(19) United States
(12) Patent Application Publication
(10) Pub. No.: US 2023/0142784 A1
(43) Pub. Date: May 11, 2023

(54) LAMINATED GLAZING

(71) Applicant: Pilkington Group Limited, Nr. Ormskirk Lancashire (GB)

(72) Inventors: Peter PAULUS, Muenster (DE); Tomasz TELEGA, Sandomierz (PL)

(73) Assignee: Pilkington Group Limited, Nr. Ormskirk Lancashire (GB)

(21) Appl. No.: 17/910,701

(22) PCT Filed: Mar. 12, 2021
(86) PCT No.: PCT/EP2021/056397

§ 371 Date: Sep. 9, 2022

(30) Foreign Application Priority Data
Mar. 12, 2020 (GB) 2003626.5
Sep. 14, 2020 (GB) 2014447.3

(51) Int. Cl. B32B 17/10; B32B 7/12

(52) U.S. Cl. CPC B32B 17/10036; B32B 7/12; B32B 17/10146; B32B 2250/02; B32B 2307/414; B32B 2307/538; B32B 2310/0843; B32B 2605/00

(57) ABSTRACT

A laminated glazing for a vehicle windscreen comprising first and second sheets of glazing material joined by a sheet of adhesive interlayer material is described. The laminated glazing has an outer facing surface and an inner facing surface comprising a first treated region that has been subjected to a roughening process such that before the roughening process the first treated region has a first surface roughness and after the roughening process the first treated region has a second surface roughness. The first treated region having the second surface roughness helps the laminated glazing break when subject to an impact on the outer facing surface. Use of a roughened region to reduce the time taken for a laminated glazing to break upon being impacted by an impactor is also described.

The present invention relates to a laminated glazing for use in an automobile, in particular for use as a windscreen in an automobile.

Conventional laminated glazings for automotive windscreens comprise two plies of soda-lime-silicate glass joined by a sheet of polyvinyl butyral (PVB). Typically, each glass sheet is 2.1 mm thick and the PVB sheet is typically 0.76 mm thick.

As is known in the art, a laminated automotive windscreen provides the driver of the vehicle with improved safety benefits. However, vehicle manufacturers are also addressing vehicle safety in the event of a forward collision with a pedestrian.

In the event of a collision with a pedestrian, the pedestrian may impact the vehicle windscreen thereby causing further injury to the pedestrian.

WO2013181505A1 describes a glass laminate including at least one chemically-strengthened glass sheet with a thickness not exceeding 2.0 mm and a polymer interlayer between the glass sheets. Flaws are created in the surface of one of the glass sheets in order to weaken the glass laminate upon an impact event on a first side of the laminate, while retaining the strength of the laminate upon impact on the opposing second side of the laminate.

EP2062862A1 describes a sheet glass laminate structure produced by laminating at least three sheet glasses each having a thickness of less than 1 mm through an intermediate layer between two adjacent sheet glasses.

The present invention aims to provide a vehicle windscreen that is arranged to lower the risks of serious pedestrian injuries in case the vehicle collides with a pedestrian.

Accordingly, from a first aspect the present invention provides a laminated glazing for a vehicle windscreen comprising a first sheet of glazing material joined to a second sheet of glazing material by at least one sheet of adhesive interlayer material, each of the first and second sheets of glazing material having a respective first major surface and second major surface, wherein the second major surface of the first sheet of glazing material faces the first major surface of the second sheet of glazing material, further wherein the second major surface of the second sheet of glazing material comprises at least a first treated region, the first treated region having been subjected to a roughening process such that prior to the roughening process the first treated region has a first surface roughness, and after the roughening process, the first treated region has a second surface roughness.

It has been found that by using a roughening process to provide the second major surface of the second sheet of glazing material with a first treated region having a second roughness, the second sheet of glazing material may break easier in the event of an impact with the first major surface of the first sheet of glazing material.

The second major surface of the second sheet of glazing material has a first area and the first treated region has a second area, and preferably the second area is less than the first area.

Preferably following the roughening process, the first treated region is translucent.

Preferably the first treated region has an outer periphery having one, or two, or three, or four, our five, or six, or seven, or eight, or nine, or ten sides.

Preferably the first treated region has four sides.

Preferably the first treated region is in the shape of a rectangle, diamond, parallelogram or square.

Preferably the first treated region has an outer edge parallel to, or substantially parallel to, at least a portion of an outer edge of the second sheet of glazing material.

Preferably the first treated region comprises at least a first portion and a second portion, the first portion being at an angle to the second portion.

In some embodiments the roughening process comprises irradiating at least a portion of the first region to be treated with a laser to laser etch the second major surface of the second sheet of glazing material in the first treated region. Following irradiation with the laser at least a portion of the first region is laser etched.

Preferably following irradiation with the laser, the first treated region comprises defects within a volume of the second sheet of glazing material, the volume being bounded on one side by the first treated region.

Preferably the laser is a carbon dioxide laser.

In some embodiments the roughening process comprises providing the first treated region of the second surface of the second sheet of glazing material with one or more scratches therein.

Preferably the scratches are randomly aligned.

Preferably the scratches are mechanically produced.

Preferably the scratches are formed by using an abrasive material.

Preferably the scratches are formed using a sandpaper.

In some embodiments the roughening process comprises abrading the first treated region of the second surface of the second sheet of glazing material.

Preferably the abrading comprises at least one sandblasting step. For the avoidance of doubt, in such embodiments the roughening process comprises at least one sandblasting step.

Preferably the first treated region is sand blasted to a depth of at least 20 µm and preferably to a maximum depth of less than 500 µm.

Preferably the first treated region is sand blasted to a depth of between A µm and B µm, wherein A is preferably 20, or 25, or 30, or 35, or 40, or 45, or 50, or 55, or 60, or 65, or 70 and wherein B is preferably 500, or 450, or 400, or 350, or 300, or 250, or 200, or 150, or 100.

In some embodiments the roughening process comprises abrading the first treated region of the second surface of the second sheet of glazing material using an acid etching step.

For the avoidance of doubt, in such embodiments the roughening process comprises at least one acid etching step.

Preferably the first treated region is acid etched to a depth of at least 20 µm and preferably to a maximum depth of less than 500 µm.

Preferably the first treated region is acid etched to a depth of between A µm and B µm, wherein A is preferably 20, or 25, or 30, or 35, or 40, or 45, or 50, or 55, or 60, or 65, or 70 and wherein B is preferably 500, or 450, or 400, or 350, or 300, or 250, or 200, or 150, or 100.

In some embodiments the first treated region has an area that is less than 10% of the area of the second major surface of the second sheet of glazing material. The area of the first treated region is kept as small as possible to not affect vision through the laminated glazing.

Preferably the first treated region has an area that is less than 5%, or 4%, or 3%, or 2%, or 1% of the area of the second major surface of the second sheet of glazing material.

In some embodiments the first treated region is one of a plurality of treated regions, and the total area of the plurality of treated regions is preferably less than 10%, or 9%, or 8%, or 7%, or 6%, or 5%, or 4%, or 3%, or 2%, or 1% of the area of the second major surface of the second sheet of glazing material.

In some embodiments first treated region is one of a plurality of treated regions and the area of the first treated region is between 0.01 cm² and 200 cm², preferably between 0.01 cm² and 100 cm², more preferably between 0.01 cm² and 10 cm², even more preferably between 0.01 cm² and 5 cm², even more preferably between 0.01 cm² and 0.5 cm².

Preferably one or more of the other treated regions in the plurality of treated regions has an area between 0.01 cm² and 200 cm², preferably between 0.01 cm² and 100 cm², more preferably between 0.01 cm² and 10 cm², even more preferably between 0.01 cm² and 5 cm², even more preferably between 0.01 cm² and 0.5 cm².

In some embodiments the first treated region in one of a plurality of treated regions, and wherein two or more of the treated regions have the same area.

Preferably all of the treated regions in the plurality of treated regions have the same area.

In some embodiments the first treated region is spaced apart from a second treated region by a first spacing, wherein the first spacing is between 0.5 cm and 50 cm, more preferably between 0.5 cm and 40 cm, more preferably between 0.5 cm and 30 cm, more preferably between 0.5 cm and 20 cm, more preferably between 0.5 cm and 10 cm.

In some embodiments the first treated region is spaced apart from a peripheral edge of the laminated glazing.

Preferably the first treated region is spaced apart from the peripheral edge of the laminated glazing by between 1 cm and 20 cm, more preferably between 1 cm and 15 cm, more preferably between 1 cm and 10 cm, more preferably between 1 cm and 9 cm or 8 cm or 7 cm or 6 cm or 5 cm.

In some embodiments the first treated region is spaced apart from a peripheral edge of the laminated glazing configured to be a lower edge of the laminated glazing when installed in a vehicle.

Preferably the first treated region is one of a plurality of treated regions spaced apart from the peripheral edge of the laminated glazing configured to be the lower edge of the laminated glazing when installed in a vehicle.

Preferably the treated regions in the plurality of treated regions spaced apart from the peripheral edge of the laminated glazing configured to be the lower edge of the laminated glazing when installed in a vehicle are arranged in a line, and preferably the line is parallel to the peripheral edge of the laminated glazing configured to be the lower edge of the laminated glazing when installed in a vehicle.

When the first treated region is one region of a plurality of treated regions, it is preferred that each treated region has an area that is the same to within +20%.

When the first treated region is one region of a plurality of treated regions, it is preferred that each treated region has the same area.

In some embodiments the first sheet of glazing material has a thickness between 1 mm and 5 mm, preferably between 1.3 mm and 3 mm

In some embodiments the second sheet of glazing material has a thickness between 1 mm and 5 mm, preferably between 1.3 mm and 3 mm.

In some embodiments the second sheet of glazing material is thinner than the first sheet of glazing material.

In some embodiments the first major surface of the first sheet of glazing material is a convex surface and the second major surface of the second sheet of glazing material is a convex surface.

In some embodiments the second surface roughness has Rz > 20 µm, preferably Rz between 20 µm and 40 µm.As is known to a person skilled in the art, Rz is the maximum height of the profile and is the sum of the largest profile peak height and the largest profile valley depth within a sampling length. The sample length may be less than 5 cm, preferably between 0.5 cm and 4 cm, or 0.5 cm and 3 cm, or 0.5 cm and 2 cm, or 0.5 cm and 1 cm. The sample length may be greater or equal to 1 cm.

In some embodiments the second surface roughness has Ra in the region of 3 µm to 6 µm.Ra is the arithmetical mean deviation of the profile within a sampling length. The sample length may be less than 5 cm, preferably between 0.5 cm and 4 cm, or 0.5 cm and 3 cm, or 0.5 cm and 2 cm, or 0.5 cm and 1 cm. The sample length may be greater or equal to 1 cm.

In some embodiments the second surface roughness has Rmax in the range 20 µm to 50 µm.Rmax is the largest single roughness depth within a sampling length. The sample length may be less than 5 cm, preferably between 0.5 cm and 4 cm, or 0.5 cm and 3 cm, or 0.5 cm and 2 cm, or 0.5 cm and 1 cm. The sample length may be greater or equal to 1 cm.

In some embodiments the second surface roughness has Rv in the range 10 µm to 20 µm.Rv is the maximum profile valley depth (Rv) within a sampling length. The sample length may be less than 5 cm, preferably between 0.5 cm and 4 cm, or 0.5 cm and 3 cm, or 0.5 cm and 2 cm, or 0.5 cm and 1 cm. The sample length may be greater or equal to 1 cm.

In some embodiments the second surface roughness has in a sample length Rz > 20 µm, preferably Rz between 20 µm and 40 µm; and/or Ra in region of 3 µm to 6 µm; and/or Rmax in the range 20 µm to 50 µm; and/or Rv in the range 10 µm to 20 µm.The sample length may be less than 5 cm, preferably between 0.5 cm and 4 cm, or 0.5 cm and 3 cm, or 0.5 cm and 2 cm, or 0.5 cm and 1 cm. The sample length may be greater or equal to 1 cm.

In some embodiments, following impact with a suitable impactor at an impact location on the first major surface of the first sheet of glazing material, the laminated glazing develops cracks in the vicinity of the impact location in less than 2 ms.

In such embodiments, the laminated glazing fully breaks within 2 ms, preferably 1 ms of the time taken for the cracks to develop.

Preferably the impactor is as described in UN Regulation No. 127 (E/ECE/324/Rev.2/Add. 126/Rev.2).

Preferably the impactor has a mass between 3 kg and 6 kg, more preferably between 4 kg and 5 kg, even more preferably a mass of 4.5 kg.

Preferably the impactor is a sphere or a spheroid and preferably has a diameter between 15 cm and 20 cm, more preferably between 16 and 17 cm.

Preferably when the impactor strikes the impact location, the velocity thereof is between 20 km/h and 50 km/h, more preferably between 35 km/h and 45 km/h, even more preferably 40 km/h.

Preferably the impactor impacts the impact location by falling under gravity alone.

The laminated glazing has other preferable features.

Preferably the laminated glazing is a vehicle windscreen.

Preferably the laminated glazing is curved in at least one direction. Preferably the radius of curvature in the at least one direction is between 500 mm and 20000 mm, more preferably between 1000 mm and 8000 mm.

Preferably the at least one sheet of adhesive interlayer material comprises polyvinyl butyral (PVB), acoustic modified PVB, a copolymer of ethylene such as ethylene vinyl acetate (EVA), polyurethane (PU), poly vinyl chloride (PVC), a copolymer of ethylene and methacrylic acid (EMA) or Uvekol (a liquid curable resin).

Preferably the at least one sheet of adhesive interlayer material is a sheet of polyvinyl butyral (PVB), EVA, PVC, EMA, polyurethane, acoustic modified PVB or Uvekol (a liquid curable resin).

Preferably the at least one sheet of adhesive interlayer material has a thickness between 0.3 mm and 2.3 mm, more preferably between 0.3 mm and 1.6 mm, most preferably between 0.3 and 0.8 mm.

Preferably the first and/or second sheet of glazing material has a thickness between 1 mm and 3 mm.

Preferably the first and/or second sheet of glazing material has a thickness between 1.4 mm and 2.8 mm, more preferably between 1.6 mm and 2.3 mm.

Preferably the first and/or second sheet of glazing material is a sheet of soda-lime-silicate glass. Soda-lime-silicate glass is often referred to as soda-lime-silica glass, or simply a sheet “soda-lime” glass.

Preferably the first and/or second sheet of glazing material is a sheet of soda-lime-silicate glass, in particular a sheet of float glass.

Preferably the first and second sheets of glazing material are not chemically strengthened. A sheet of glazing material may be classified as not being chemically strengthened when the sheet of glazing material has not been subject to an ion exchange process, or has been subject to an ion exchange process following which the depth of layer is between 0 µm and DOL µm, where DOL is 1, or 2, or 3, or 4, or 5.

In some embodiments the second sheet of glazing material is a sheet of alkali aluminosilicate glass.

Preferably the second sheet of glazing material comprises at least about 6wt% (percent by weight) aluminium oxide (Al₂O₃).

In some embodiments the second sheet of glazing material is chemically strengthened i.e. chemically strengthened glass. When the second sheet of glazing material is chemically strengthened, preferably the second sheet of glazing material has a thickness less than 1.2 mm, more preferably between 0.3 mm and 1 mm, even more preferably between 0.4 mm and 0.9 mm.

The present invention also provides use of one or more roughened region on a first exposed surface of a laminated glazing to reduce the time taken for the laminated glazing to break upon being impacted by a suitable impactor at an impact region on a second exposed surface of the laminated glazing.

Preferably the roughened region comprises a sandblasted region and/or a laser etched region.

Preferably the first exposed surface of the laminated glazing is surface four of the laminated glazing and the second exposed surface is surface one of the laminated glazing.

As is conventional in the art, surface one of a laminated glazing is an outermost surface of the laminated glazing and surface four of the laminated glazing is an inner facing surface being defined in relation to a vehicle interior in which the laminated glazing is installed. The inner facing surface of the laminated glazing faces the interior of the vehicle in which the laminated glazing is installed. The outermost surface (often referred to as the outer surface) faces the exterior of the vehicle in which the laminated glazing is installed.

Preferably the impactor is as described in UN Regulation No. 127 (E/ECE/324/Rev.2/Add. 126/Rev.2).

Preferably the impactor has a mass between 3 kg and 6 kg, more preferably between 4 kg and 5 kg, even more preferably a mass of 4.5 kg.

Preferably the impactor is a sphere or a spheroid and preferably has a diameter between 15 cm and 20 cm, more preferably between 16 and 17 cm.

Preferably when the impactor strikes the impact location, the velocity thereof is between 20 km/h and 50 km/h, more preferably between 35 km/h and 45 km/h, even more preferably 40 km/h.

Preferably the impactor impacts the impact location by falling under gravity alone.

Preferably the time taken for the laminated glazing to break upon being impacted by the impactor is at least 50%, or 60%, or 70% or 80% shorter than the time taken for the laminated glazing to break without the laminated glazing having the one or more sandblasted region on the first exposed surface.

The present invention will now be described with reference to the following figures in which:

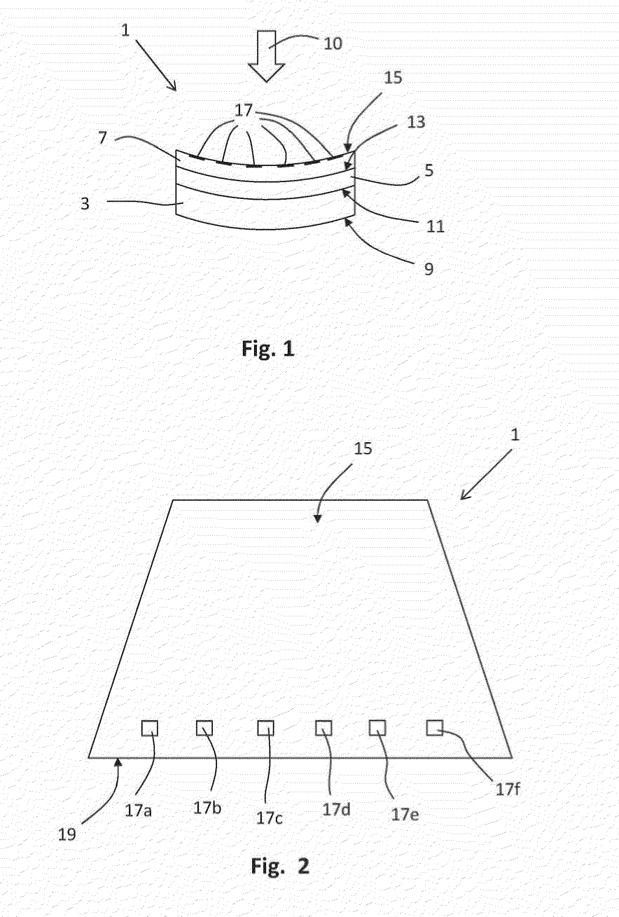

FIG. 1 is a cross section view of a laminated glazing according to the present invention;

FIG. 2 is a plan view of a laminated glazing in accordance with the present invention;

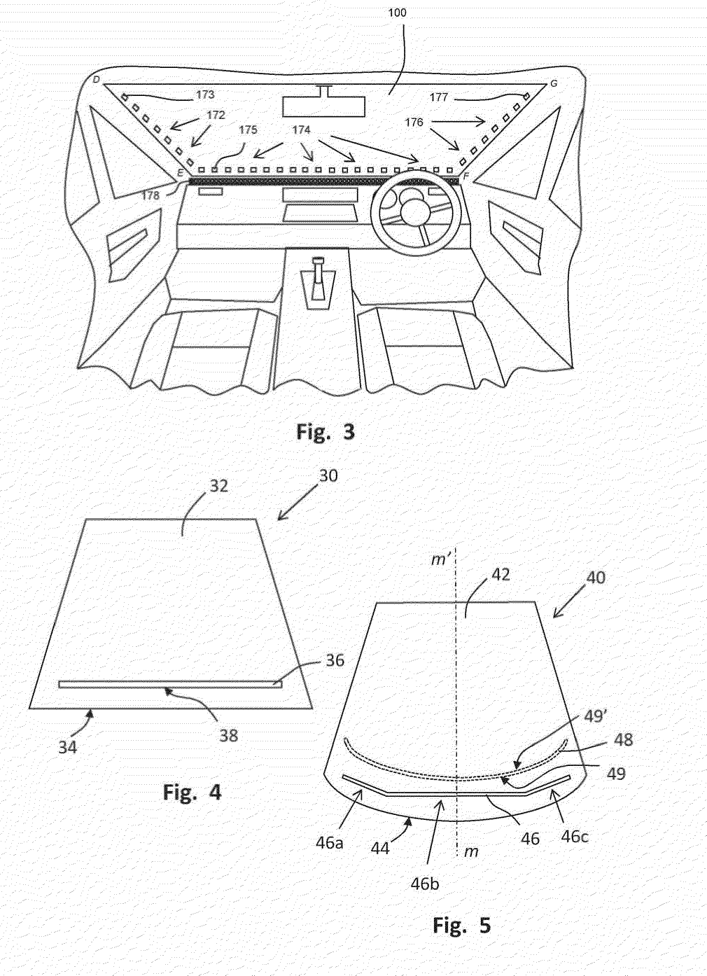

FIG. 3 is the view from inside a vehicle that has a windscreen in accordance with the present invention;

FIG. 4 is similar to FIG. 2 and is a plan view of another laminated glazing in accordance with the present invention;

FIG. 5 is similar to FIG. 2 and is a plan view of another laminated glazing in accordance with the present invention;

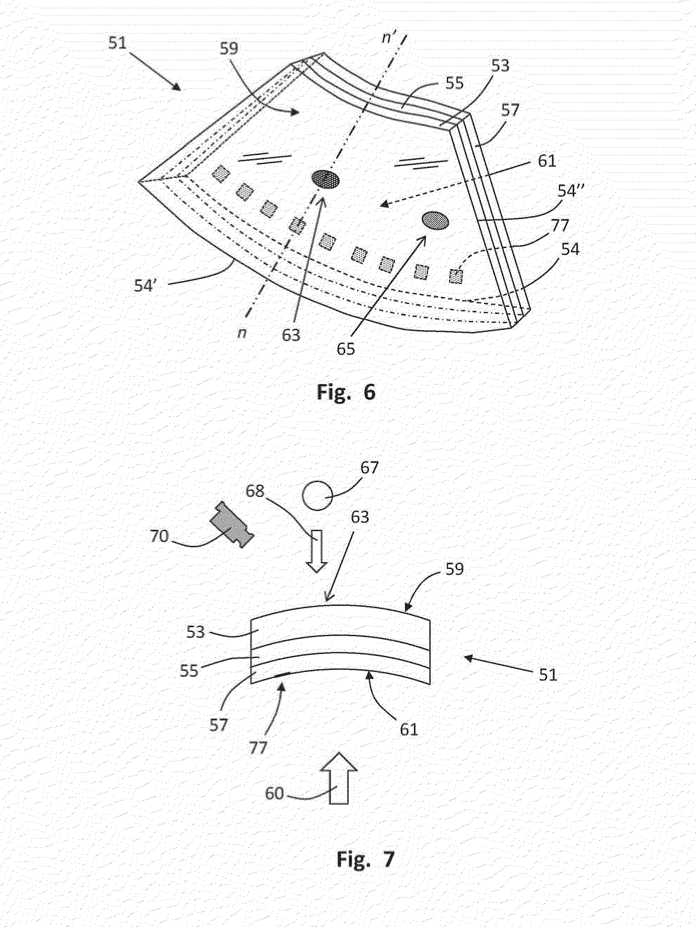

FIG. 6 is a schematic isometric representation of a windscreen of the type described with reference to FIG. 1; and

FIG. 7 is a schematic cross-sectional representation of a method to test the breakage properties of a vehicle windscreen of the type shown in FIG. 6.

FIG. 1 shows a cross section of a curved laminated glazing in accordance with the present invention.

The laminated glazing 1 has a first sheet 3 of soda-lime-silicate glass having a composition such as clear float glass, typically with the addition of iron oxide as a tinting agent to provide the laminated glazing with some form of solar control. The first sheet 3 has a thickness of 2.3 mm although the thickness may be in the range 1.4 mm to 2.5 mm or in the range 1.6 mm to 2.3 mm.

A typical soda-lime-silicate glass composition is (by weight), SiO₂ 69 - 74%; Al₂O₃ 0 - 3%; Na₂O 10 - 16%; K₂O 0 - 5 %; MgO 0 - 6%; CaO 5 - 14%; SO3 0 - 2%; Fe₂O₃ 0.005 - 2%. The glass composition may also contain other additives, for example, refining aids, which would normally be present in an amount of up to 2%. The soda-lime-silica glass composition may contain other colouring agents such as Co₃O₄, NiO and Se to impart to the glass a desired colour when viewed in transmitted light. The transmitted glass colour may be measured in terms of a recognised standard such as BS EN410.

The laminated glazing 1 also has a second sheet 7 of soda-lime-silicate glass having a thickness of 1.6 mm, but the second sheet may have a thickness may be in the range 1.4 mm to 2.5 mm and is preferably not as thick as the first sheet 3.

The first sheet 3 is joined to the second sheet 7 by an adhesive interlayer 5. The adhesive interlayer 5 is a 0.76 mm thick sheet of PVB. The adhesive interlayer 5 may have a thickness between 0.3 mm and 1.8 mm.

Other suitable adhesive interlayers include PVC, EVA, EMA and polyurethane.

The laminated glazing 1 is curved in one or more directions. The radius of curvature in one of the one or more directions is between 1000 mm and 8000 mm.

When the laminated glazing is curved in two directions, suitably each direction of curvature is orthogonal to the other. Suitably the radius of curvature in one or both directions of curvature is between 1000 mm and 8000 mm.

The first sheet 3 has a convex first surface 9 and an opposing concave second surface 11. The second sheet 7 has a convex first surface 13 and an opposing concave second surface 15. The concave surface 11 of the first sheet 3 is in contact with the adhesive interlayer 5 and the convex surface 13 of the second sheet 7 is in contact with the adhesive interlayer 5. Using conventional nomenclature, the convex surface 9 of the first sheet 3 is “surface one” (or S1) of the laminated glazing 1, the concave surface 11 of first sheet 3 is “surface two” (or S2) of the laminated glazing 1, the convex surface 13 of second sheet 7 is “surface three” (or S3) of the laminated glazing 1 and the concave surface 15 of second sheet 7 is “surface four” (or S4) of the laminated glazing 1.

There is an array of treated regions 17 on surface four (the concave surface 15 of second sheet 7).

FIG. 2 is a plan view of the laminated glazing 1 in the direction of arrow 10 of FIG. 1.

In FIG. 2, the periphery of the laminated glazing is typical of a vehicle windscreen. The laminated glazing has a lower peripheral edge 19 and inboard of the lower peripheral edge 19 are six sandblasted regions 17a, 17b, 17c, 17c, 17e, 17f that form the array of treated regions 17. The sandblasted regions 17a, 17b, 17c, 17c, 17e, 17f have a different roughness compared to the roughness of the untreated surface 15 surrounding them.

Each sandblasted region 17a, 17b, 17c, 17c, 17e, 17f is a square with 2 cm sides such that the area of each sandblasted region 17a, 17b, 17c, 17c, 17e, 17f is 4 cm².

The sandblasted regions 17a, 17b, 17c, 17c, 17e, 17f are equally spaced such that the space between sandblasted region 17a and 17b is the same as the space between sandblasted region 17b and 17c, and so on.

The sandblasted regions 17a, 17b, 17c, 17c, 17e, 17f lie in a line that is parallel to the lower peripheral edge 19.

The sandblasted regions may be in a region of the laminated glazing where there is an obscuration band on the concave surface 15 of the second sheet 7.

By providing the sandblasted regions 17a, 17b, 17c, 17c, 17e, 17f, in the event of an impact on the convex first surface 9 of the first sheet 3, the second sheet 7 can break more easily so that the rigidity of the laminated glazing 1 is reduced. When the laminated glazing 1 is installed as a windscreen in a vehicle, in the event of a pedestrian being involved in a collision with the vehicle, the reduction in rigidity of the windscreen upon an impact with the convex first surface 9 reduces the seriousness of injury to the pedestrian.

Although FIGS. 1 and 2 have only six sandblasted regions, there may be more than six sandblasted regions or less than six sandblasted regions. In some embodiments there are seven or eight or nine or ten or more sandblasted regions. In some embodiments, there are one, or two, or three, or four, or five sandblasted regions. It is preferred to have the sandblasted regions equally spaced from one another. It is also preferred each sandblasted region is sandblasted to the same depth and/or has the same dimensions and geometric shape, however in some embodiments one or more sandblasted region has been sandblasted to a different depth compared to one or more other sandblasted regions.

Another embodiment of the present invention is shown in FIG. 3.

FIG. 3 shows the view from inside a vehicle that has a windscreen 100 in accordance with the present invention.

The windscreen 100 is essentially the same as the laminated glazing 1 previously described. The vehicle windscreen has a lower peripheral edge extending between the points E and F. The vehicle windscreen has an upper peripheral edge extending between the points D and G.

On the surface four (the inner facing surface) of the windscreen 100 are a plurality of sandblasted regions. There is a first array of sandblasted regions 174 has twenty square regions (only one of which is labelled 175). Each square region 175 has dimensions of between 1x1cm and 3x3cm. It is preferred all the squares 175 have the same size and/or area. The squares 175 are arranged in a line running parallel to the lower peripheral edge E-F i.e. the lower sides of the squares 175 are parallel to the lower peripheral edge E-F. The squares 175 may be orientated differently.

In this embodiment also on surface four of the windscreen 100 is a second array of sandblasted regions 172 running along the left hand peripheral edge D-E of the windscreen 100 and a third array of sandblasted regions 176 running along the right hand peripheral edge The second array of sandblasted regions 172 has seven square regions (only one of which is labelled 173) with a lower side thereof being parallel to the left hand peripheral edge D-E. The third array of sandblasted regions 176 also has seven square regions (only one of which is labelled 177) with a lower side thereof being parallel to the right-hand peripheral edge F-G.

Each of the sandblasted regions in the second and third arrays are the same size and/or have the same area.

With reference to FIG. 2, the sandblasted regions are made using a conventional sandblasting apparatus of the type used to sandblast the surface of a glass sheet. Each region 17a, 17b, 17c, 17c, 17e, 17f is sandblasted to a depth between 50 µm and 150 µm, but may be deeper, for example to a depth between 250 and 400 µm.

Prior to sandblasting the regions to be treated 17a, 17b, 17c, 17c, 17e, 17f have the same roughness as the glass sheet and is smooth. Following sandblasting the treated regions 17a, 17b, 17c, 17c, 17e, 17f are made rougher. According to “Glass Processing Days, 13-15 Sept 1997, pages 40-44, the surface roughness of float glass has Rz < 0.1 µm. It is preferred that the treated regions be translucent following the treating process i.e. sandblasting, scratching, acid etching.

Using a suitable profiling sensor such as a stylus or confocal displacement sensor, roughness parameters of the sandblasted float glass sheet may be determined. The use of a confocal displacement sensor to evaluate surface profile parameters is described in “Procedia Materials Science, 5 (2014) p. 1385 - 1391″.

Using a Hommel Tester T500 Profilometer available from Hommelwerke GmbH, Alte Tuttlinger Straße 20, D-78056 VS-Schwenningen, Germany, it was found that sandblasting could be used to adjust the surface roughness of a 20 mm x 20 mm square region on a sheet of float glass to have Rz > 20 µm, typically between 20 µm and 40 µm. As is known to a person skilled in the art, Rz is the maximum height of the profile and is the sum of the largest profile peak height and the largest profile valley depth within a sampling length.

Another parameter often used to define the roughness of a surface is the arithmetical mean deviation of the profile within a sampling length (usually abbreviated as Ra in the art). It was found sandblasting a 20 mm x 20 mm region of a float glass surface it possible to produce an Ra in region of 3 µm to 6 µm.

Other parameters to define surface roughness may be used, for example the largest single roughness depth (Rmax) within a sampling length or the maximum profile valley depth (Rv) within a sampling length. By sandblasting a 20 mm x 20 mm region of a float glass surface it was possible to produce an Rmax in the range 20 µm to 50 µm and an Rv in the range 10 µm to 20 µm.

Specific examples of four different sandblasted regions 20 mm x 20 mm on a float glass sheet measured with the Hommel Tester T500 Profilometer were:
(i) Ra = 3.768 µm, Rz = 22.159 µm, Rmax = 26.173 µm and Rv =11.811 µm;
(ii) Ra = 3.775 µm, Rz = 20.441 µm, Rmax = 23.417 µm and Rv =10.405 µm;
(iii) Ra = 5.017 µm, Rz = 35.720 µm, Rmax = 47.800 µm and Rv =18.100 µm;
(iv) Ra = 5.093 µm, Rz = 33.666 µm, Rmax = 37.109 µm and Rv =19.213 µm.

FIG. 4 is a plan view towards surface four (S4) of another laminated glazing 30 having a similar construction to the laminated glazing 1. FIG. 4 is similar to the view in FIG. 2 so the view thereof is in the direction of arrow 10 of FIG. 1.

The laminated glazing 30 has a first sheet of glass having a thickness of 2.1 mm joined to a second sheet of glass 32 having a thickness of 1.6 mm by means of a sheet of PVB having a thickness of 0.76 mm.

In FIG. 4, the periphery of the laminated glazing 30 is typical of a vehicle windscreen. The laminated glazing 30 has a lower peripheral edge 34 and inboard of the lower peripheral edge 34 part of surface four has been sandblasted to provide a rectangular sandblasted region 36. The rectangular sandblasted region 36 has a width of about 5 mm, although the width thereof may be between 2 mm and 50 mm. The rectangular sandblasted region 36 has a lower edge 38 that is parallel to the lower peripheral edge 34 of the laminated glazing.

The sandblasted region 36 may be in a region of the laminated glazing where there is an obscuration band and the obscuration band may be provided with a window therein where the sandblasted region is located.

In an alternative to the example shown in FIG. 4, there may be at least first and second rectangular sandblasted regions that are spaced apart from each other. The first and second rectangular sandblasted regions each have a respective lower edge and preferably the lower edge of the first rectangular sandblasted region is parallel to the lower edge of the second rectangular sandblasted region. It is also preferred that the lower edges of the first and second sandblasted regions are parallel to the lower peripheral edge 34. There may be a plurality of such spaced apart sandblasted rectangular regions, each having the same or different width and being spaced apart from each other by the same or different spacing.

FIG. 5 is a plan view towards surface four of another laminated glazing 40 having a similar construction to the laminated glazing 1 (so is a view in the direction of arrow 10 of FIG. 1).

The laminated glazing 40 comprises a first sheet of soda-lime-silicate glass having a thickness of 1.8 mm joined to a second sheet 42 of soda-lime-silicate glass having a thickness of 1.8 mm by means of a sheet of PVB having a thickness of 0.76 mm.

The laminated glazing 40 has a lower peripheral edge 44 that is curved and inboard of the lower peripheral edge 44 part of surface four has been sandblasted to provide a sandblasted region 46. The sandblasted region 46 has three portions 46a, 46b and 46c forming the continuous sandblasted region 46.

Each portion 46a, 46b, 46c is rectangular and the portions are arranged to substantially follow the contour of the lower edge 44.

Also provided on surface 4 of the laminated glazing 40 is a second sandblasted region 48.

The second sandblasted region 48 is curved and has a lower edge 49 that is substantially parallel to the lower peripheral edge 44 of the laminated glazing 40. The second sandblasted region 48 also has an upper edge 49′ that is preferably parallel to the lower edge 49. The spacing of the upper and lower edges 49′, 49 is between 2 mm and 50 mm, i.e. 2 mm to 10 mm, and may be about 5 mm.

The laminated glazing 40 may be provided with either or both sandblasted regions 46, 48. If there are two sandblasted regions 46, 48 (as shown in FIG. 5), the relative positions thereof may be switched such that the second sandblasted region 48 is between the lower edge 44 and the sandblasted region 46.

The sandblasted regions 46, 48 are symmetrical about the axis m-m′, which is the centreline of the laminated glazing 40.

Although the sandblasted regions 46, 48 are each shown as being continuous sandblasted regions, in other examples of the invention one or both sand blasted region 46, 48 may be formed by a plurality of disconnected sandblasted regions having essentially the same overall shape as the sand blasted regions 46, 48.

In order to test the effect of having portions of surface four of the laminated glazing being roughened, for example by sandblasting, the ease with which a laminated glazing broke was determined.

With reference to FIGS. 6 and 7, a laminated glazing to be tested was constructed using conventional lamination conditions and comprises a first sheet 53 of soda-lime-silicate glass joined to a second sheet 57 of soda-lime-silicate glass by means of a sheet of PVB 55. The laminated glazing was in the form of a vehicle windscreen and may have obscuration bands thereon, as is conventional in the art. Neither of the first or second sheets 53, 55 was chemically strengthened.

The first sheet 53 has an exposed major surface 59, and this is “surface one” (or S1) of the laminated glazing 51. The major surface 59 is convex.

The second sheet 57 has an exposed major surface 61, and this is “surface four” (or S4) of the laminated glazing 51. The major surface 61 is concave.

Portions of the major surface 61 were sandblasted. In FIG. 6, there are nine sand blasted square regions 77 (only one of which is labelled), so the plan view of the laminated glazing 51 in the direction of arrow 60 is similar to that shown in FIG. 2 (except there are nine squares and not six).

In FIG. 6, each square is 2 cm by 2 cm and spaced apart from an adjacent square by about 10 cm -15 cm and the spacing may be uniform. The centre of each square is between 60 mm and 100 mm from the lower edge 54 of the laminated glazing 51. The lower edge of each square is arranged to follow the contour of the lower edge 54 such that the nine square are not arranged in a straight line, but instead in a curve that is similar (or the same) to the curvature of the lower edge 54. The squares may however be arranged in a straight line.

Whatever the arrangement of sandblasted regions, the laminated glazing was tested as follows, and with reference to FIGS. 6 and 7.

The laminated glazing 51 was first positioned in a horizontally arranged frame (not shown) and clamped therein about the periphery. The major surface 59 (“surface one”) was facing upwards and able to be freely contacted i.e. the frame does not impede contact with the major surface 59.

An impactor 67 is then dropped onto surface 59 at one of two locations. Due to the destructive nature of the test, it is only possible to test one laminated glazing at one impact location.

The first impact location 63 is at a central position and lies substantially on the centreline n-n′ of the laminated glazing, about 15 cm - 30 cm away from the lower edge 54′ of the laminated glazing, the actual distance away from the lower edge 54′ of the laminated glazing being kept the same in the tests.

The second impact location 65 is towards the side of the laminated glazing and is representative of that portion of the laminated glazing directly in front of a driver of a vehicle in which the laminated glazing 51 would be installed. As the laminated glazing is symmetrical about the centreline n-n′, the second impact position is essentially the same as that portion of the laminated glazing directly in front of a front passenger of the vehicle in which the laminated glazing 51 would be installed.

The second impact location is about 15-30 cm away from the side 54″ of the laminated glazing and about 15 cm - 30 cm from the lower edge 54′, the actual distance away from the side 54″ of the laminated glazing and the lower edge 54′ being kept the same in the tests.

The impactor 67 used in the tests is a plastic hollow spheroid filled with steel shot and covered with felt. The overall weight of the impactor 67 is 4.5 kg and the overall diameter is 165 mm.

The impactor used in the tests is similar to that specified in UN Regulation No. 127 (E/ECE/324/Rev.2/Add. 126/Rev.2).

The impactor 67 was positioned directly above the first or second impact location at a height sufficient for the impactor to reach a speed of 40 km/h at the chosen impact location (by equating the potential energy to the acquired kinetic energy). With reference to FIG. 7, the impactor 67 is directly above the first impact location 63 and will be released to fall under gravity in the direction of arrow 68 to strike the major surface 59 at the first impact location 63.

To ensure the same impact position on each sample, a plumb line may be used to position the impactor 67 at the desired position for contact with the glass surface when dropped.

To assess the way the laminated glazing breaks when the impactor 67 is dropped onto the laminated glazing 51 as described above, the test is recorded using a video camera 70 positioned above the laminated glazing 51. The video camera 70 operates at a high frame rate, for example a thousand frames per second (1000fps).

To classify the ease with which the laminated glazing 51 breaks, two breakage criteria were identified by examining the video recording made during the test.

The first breakage criteria is referred to as the “Initial Breakage Time” and is the time taken for the first cracking to be seen in the laminated glazing following the impactor 67 making contact with the major surface 59 at the chosen impact location.

The second breakage criteria is referred to as the “Full Breakage Time” and is the time taken for the laminated glazing 51 to undergo catastrophic breakage following the impactor 67 making contact with the major surface 59 at the chosen impact location.

To help identify the Initial Breakage Time and/or the Full Breakage Time, one or more reference marks may be provided on major surface 59, especially in the region of the chosen impact location. The reference marks may be in the form of a grid and may be applied to the major surface 59 using a suitable pen or the like.

A number of laminated glazing samples were evaluated as described above. Each laminated glazing had essentially the same degree of curvature. The results are provided in table 1.

The samples in table 1 are defined in terms of an outer pane and an inner pane. With reference to FIGS. 6 and 7, the first sheet 53 is referred to as an “outer pane”, because when the laminated glazing 51 is installed in a vehicle, the first sheet 53 faces the exterior of the vehicle. Accordingly, the second sheet 57 is referred to as an “inner pane”, because when the laminated glazing 51 is installed in a vehicle, the second sheet 57 faces the interior of the vehicle. The impactor 67 therefore strikes the outer pane to simulate the impact with a pedestrian who may be involved in a forward collision with a vehicle in which the laminated glazing 51 is installed.

The sample details and results are provided in table 1. Each of the inner and outer panes is a sheet of soda-lime-silicate glass at the quoted thickness. The inner and outer panes are joined by a sheet of PVB 0.76 mm thick. Neither of the inner and outer panes was chemically strengthened in these samples.

Two different type of sandblasted region on surface four of the samples was evaluated. The first type of sandblasted region was nine squares 2 cm by 2 cm, as described with reference to FIGS. 6 and 7. The second type of sandblasted region that was evaluated was as described in relation to region 46 in FIG. 5 and had an overall length of about 1.4 m and a width of about 5 mm. With reference to FIG. 5, in the tests carried out the two lateral portions 46a, 46c were both rectangular in shape and were about 40 cm long, and the central portion 46b was also rectangular and about 60 cm long and substantially horizontal relative to the horizon when the laminated glazing was installed in a vehicle. The lateral portions 46a, 46c were inclined at an angle to central portion 46b of about 20° to 30°, essentially determined by the curvature of the lower peripheral edge of the sample.

In the table 1 below, the first type of sandblasted region are labelled “Squares”, and the second type of sandblasted region are labelled “Stripe”. The first impact location is referred to as “Central”, and the second impact location is referred to as “Driver”.

Also provided in the table, for each sample the average depth of the sandblasted region(s) measured using the Hommel Tester T500 Profilometer are provided.

The Initial Breakage Time and the Full Breakage Time are each provided in milliseconds (ms).

In table 1 below, samples Comparative 1-4 have inner and outer panes of soda-lime-silicate glass of thickness 1.8 mm joined by a 0.76 mm sheet of PVB. Samples Comparative 5-8 have inner and outer panes of soda-lime-silicate glass of thickness 1.4 mm and 1.8 mm respectively joined by a 0.76 mm sheet of PVB. There are no sandblasted regions on the Comparative samples 1 - 8.

The results in table 1 show that without any sandblasted regions (Comparative 1-8), the laminated glazing has an Initial Breakage Time between 4-6 ms after surface 59 is struck by the impactor 67 at the chosen impact region. The majority of the Comparative samples have an Initial Breakage Time of 5 ms.

As can be seen from table 1, the Final Breakage Time occurs shortly after the Initial Breakage Time, typically within a millisecond thereof.

The results in table 1 illustrate that providing surface four of the laminated glazing with sandblasted regions (of the type previously described), the Initial Breakage Time is reduced from 4 ms to around 1 ms or less. The Final Breakage Time is also reduced.

This indicates that upon an impact with surface one of the windscreen, for example by a forward collision with a pedestrian, the windscreen having the sandblasted regions is easier to break. The reduction in the rigidity of the windscreen upon breakage may result in less serious injury to the pedestrian.

It is to be expected that instead of an array of sandblasted square regions, as described with reference to FIGS. 2, 3 and 6, other shape regions would behave in a similar manner, for example diamonds, circles, trapeziums, or other irregular shapes. Symmetrical regions and/or same shaped regions may provide the laminated glazing with the benefits detailed in table 1 at more than one multiple impact location on the surface one of the windscreen.

It also may be expected that similar benefits are observed when using other similar tests to determine the breakage properties of the laminated glazing, for example as described in UN Regulation No. 127 (E/ECE/324/Rev.2/Add. 126/Rev.2).

TABLE 1

| Sample Reference | Laminate Construction (outer pane/0.76 mm PVB/ inner pane) | | Impact Region | Sandblasted Region Type | Average Depth of Sandblasted Regions | Initial Breakage Time | Final Breakage Time |
|---|---|---|---|---|---|---|---|
| | outer pane (mm) | inner pane (mm) | | | (µm) | (ms) | (ms) |
| Comparative 1 | 1.8 | 1.8 | Central | None | n/a | 5 | 6 |
| Comparative 2 | 1.8 | 1.8 | Central | None | n/a | 5 | 6 |
| Comparative 3 | 1.8 | 1.8 | Central | None | n/a | 5 | 5 |
| Comparative 4 | 1.8 | 1.8 | Central | None | n/a | 5 | 5 |
| Comparative 5 | 1.8 | 1.4 | Central | None | n/a | 6 | 6 |
| Comparative 6 | 1.8 | 1.4 | Central | None | n/a | 5 | 5 |
| Comparative 7 | 1.8 | 1.4 | Central | None | n/a | 4 | 5 |
| Comparative 8 | 1.8 | 1.4 | Central | None | n/a | 5 | 5 |
| Example 1 | 1.8 | 1.8 | Driver | Squares | 250 | 1 | 1 |
| Example 2 | 1.8 | 1.8 | Driver | Squares | 250 | 1 | 1 |
| Example 3 | 2.1 | 1.6 | Central | Squares | 75.4 | 1 | 4 |
| Example 4 | 2.1 | 1.6 | Central | Squares | 73.0 | 1 | 2 |
| Example 5 | 2.1 | 1.6 | Central | Squares | 75.4 | 1 | 4 |
| Example 6 | 2.1 | 1.6 | Central | Squares | 80.8 | 1 | 4 |
| Example 7 | 2.1 | 1.6 | Central | Squares | 55.2 | 1 | 4 |
| Example 8 | 2.1 | 1.6 | Central | Squares | 66.2 | 1 | 2 |
| Example 9 | 2.1 | 1.6 | Central | Squares | 72.2 | 1 | 1 |
| Example 10 | 2.1 | 1.6 | Driver | Squares | 107.3 | 1 | 3 |
| Example 11 | 2.1 | 1.6 | Driver | Squares | 137.0 | 1 | 3 |
| Example 12 | 2.1 | 1.6 | Driver | Squares | 116.1 | 1 | 4 |
| Example 13 | 2.1 | 1.6 | Driver | Squares | 149.0 | 1 | 4 |
| Example 14 | 2.1 | 1.6 | Driver | Squares | 100.2 | 1 | 4 |
| Example 15 | 2.1 | 1.6 | Driver | Squares | 98.6 | 1 | 4 |
| Example 16 | 2.1 | 1.6 | Driver | Squares | 104.5 | 1 | 3 |
| Example 17 | 2.1 | 1.6 | Driver | Stripe | 55.1 | 1 | 4 |
| Example 18 | 2.1 | 1.6 | Driver | Stripe | 78.7 | 1 | 1 |
| Example 19 | 2.1 | 1.6 | Driver | Stripe | 105.3 | 1 | 4 |
| Example 20 | 2.1 | 1.6 | Driver | Stripe | 93.9 | 1 | 3 |
| Example 21 | 2.1 | 1.6 | Driver | Stripe | 86.7 | 1 | 1 |
| Example 22 | 2.1 | 1.6 | Driver | Stripe | 88.8 | 1 | 3 |
| Example 23 | 2.1 | 1.6 | Driver | Stripe | 165.7 | 1 | 3 |
| Example 24 | 2.1 | 1.6 | Driver | Stripe | 104.8 | 1 | 3 |
| Example 25 | 2.1 | 1.6 | Driver | Stripe | 84.3 | 1 | 4 |
| Example 26 | 2.1 | 1.6 | Central | Stripe | 98.2 | 1 | 3 |
| Example 27 | 2.1 | 1.6 | Central | Stripe | 125.3 | 1 | 3 |
| Example 28 | 2.1 | 1.6 | Central | Stripe | 116.6 | 1 | 4 |
| Example 29 | 2.1 | 1.6 | Central | Stripe | 103.3 | 1 | 4 |
| Example 30 | 2.1 | 1.6 | Central | Stripe | 51.9 | 1 | 4 |
| Example 31 | 2.1 | 1.6 | Central | Stripe | 52.1 | 1 | 4 |
| Example 32 | 2.1 | 1.6 | Central | Stripe | 89.6 | 1 | 4 |
| Example 33 | 2.1 | 1.6 | Central | Stripe | 138.5 | 1 | 4 |

It has been found that by having treated regions of the inner facing surface of the laminated windscreen, the inner facing glass sheet is easier to break in the event of a pedestrian colliding with the outer facing surface of the laminated windscreen. The treated regions are positioned not to be visually distracting to the vehicle driver and do not reduce the performance of the windscreen in stone impact tests.

1. A laminated glazing for a vehicle windscreen comprising a first sheet of glazing material joined to a second sheet of glazing material by at least one sheet of adhesive interlayer material, each of the first and second sheets of glazing material having a respective first major surface and second major surface, wherein the second major surface of the first sheet of glazing material faces the first major surface of the second sheet of glazing material, further wherein the second major surface of the second sheet of glazing material comprises at least a first treated region, the first treated region having been subjected to a roughening process such that prior to the roughening process the first treated region has a first surface roughness, and after the roughening process, the first treated region has a second surface roughness.

2. A laminated glazing according to claim 1, wherein the first treated region is translucent to visible light.

3. (canceled)

4. A laminated glazing according to claim 1, wherein the roughening process comprises providing the first treated region of the second surface of the second sheet of glazing material with one or more scratches therein.

5. A laminated glazing according to claim 4, wherein the scratches are mechanically produced.

6. A laminated glazing according to claim 1, wherein the roughening process comprises abrading the first treated region of the second surface of the second sheet of glazing material.

7. A laminated glazing according to claim 1, wherein first treated region comprises a sandblasted region or an acid etched region.

8. A laminated glazing according to claim 1, wherein the first treated region following the roughening process is a sandblasted region having a sandblasted depth of at least 20 µm and/or less than 500 µm.

9. (canceled)

10. A laminated glazing according to claim 1, wherein the first treated region is one of a plurality of treated regions, and the total area of the plurality of treated regions is less than 10% of the area of the second major surface of the second sheet of glazing material and/or wherein the first treated region is one of a plurality of treated regions and the area of the first treated region is between 0.01 cm² and 200 cm².

11. (canceled)

12. (canceled)

13. (canceled)

14. (canceled)

15. (canceled)

16. (canceled)

17. (canceled)

18. A laminated glazing according to claim 1, wherein the first sheet of glazing material has a thickness between 1 mm and 5 mm and/or wherein the second sheet of glazing material has (i) a thickness between 1 mm and 5 mm or (ii) is chemically strengthened and has a thickness less than 1.2 mm.

19. (canceled)

20. (canceled)

21. A laminated glazing according to claim 1, wherein the first treated region is in a region of the laminated glazing having an obscuration band thereon.

22. A laminated glazing according to claim 1, wherein the roughening process comprises irradiating at least a portion of the first region to be treated with a laser to laser etch the second major surface of the second sheet of glazing material in the first treated region.

23. A laminated glazing according to claim 22, wherein in a volume of the second sheet of glazing material bounded by the first treated region, defects are formed following irradiation with the laser.

24. (canceled)

25. A laminated glazing according to claim 1, wherein the second surface roughness has Rz > 20 µm.

26. A laminated glazing according to claim 1, wherein the second surface roughness has Ra in the region of 3 µm to 6 µm.

27. A laminated glazing according to claim 1, wherein the second surface roughness has Rmax in the range 20 µm to 50 µm.

28. A laminated glazing according to claim 1, wherein the second surface roughness has Rv in the range 10 µm to 20 µm.

29. A laminated glazing according to claim 1, wherein following impact with an impactor at an impact location on the first major surface of the first sheet of glazing material, the laminated glazing develops cracks in the vicinity of the impact location in less than 2 ms, wherein (i) the impactor is as described in UN Regulation No. 127 (E/ECE/324/Rev.2/Add. 126/Rev.2); or (ii) the impactor has a mass between 3 kg and 6 kg and/or wherein the impactor is a sphere or a spheroid and/or when the impactor strikes the impact location, the velocity thereof is between 20 km/h and 50 km/h.

30. (canceled)

31. Use of one or more roughened region on a first exposed surface of a laminated glazing to reduce the time taken for the laminated glazing to break upon being impacted by a suitable impactor at an impact region on a second exposed surface of the laminated glazing.

32. Use according to claim 31 wherein the first exposed surface is surface four of the laminated glazing and the second exposed surface is surface one of the laminated glazing.

33. (canceled)

34. Use according to claim 31, wherein, wherein the roughened region comprises a sandblasted region and/or a laser etched region.
